(19) United States
(12) Patent Application Publication
(10) Pub. No.: US 2004/0214126 A1
(43) Pub. Date: Oct. 28, 2004

(54) Orthodontic expansion screw, especially palatinal split screw

(76) Inventors: Rolf Forster, Pforzheim (DE); Carsten Wagner, Bretten-Sprantal (DE)

Correspondence Address: ORUM & ROTH, 53 W. JACKSON BLVD, CHICAGO, IL, 60604, US

(21) Appl. No.: 10/829,871

(22) Filed: Apr. 22, 2004

(30) Foreign Application Priority Data
Apr. 25, 2003 (DE) 203 06 865.3

(51) Int. Cl. A61C 3/00

(52) U.S. Cl. 433/7

(57) ABSTRACT

The invention describes an orthodontic expansion screw having two bodies (1 2) whose mutual spacing can be varied by means of a spindle (3) acting upon the two bodies (1, 2),

having straight-line guide means which are in engagement with the two bodies (1, 2) and which guide the latter along two mutually parallel guide axes defining a first plane (21), while preventing any relative rotation of the bodies (1, 2) during adjustment of their spacing,

and having angled or bent-off retention arms (11, 12, 13, 14) mounted on the bodies (1, 2), comprising a first leg (11a, 12a, 13a, 14a) each mounted on one of the bodies (1, 2), the longitudinal axis of the first legs (11a, 12a, 13a, 14a) defining together a second plane (22),

and comprising a second leg (11b, 12b, 13b, 14b) which is angled or bent off relative to the first leg (11a, 12a, 13a, 14a),

there being provided for the expansion screw, in accordance with its intended purpose, an installed condition in which all second legs (11b, 12b, 13b, 14b) extend on the same side of the second plane (22). It is provided according to the invention that the angled and/or bent-off second legs (11b, 12b, 13b, 14b) of the retention arms (11, 12, 13, 14) intersect the first plane (21) in the intended installed position.

The present invention relates to an orthodontic expansion screw having the features defined in the preamble of claim 1. An expansion screw of this kind is known in the form of a palatinal split screw from DE 196 37 132 A1. It serves to widen an excessively narrow upper jaw by opening the palatine suture in the upper jaw. To this end, straps are attached to opposite molars of the upper jaw, and are welded to arms, which in their turn are fixed to the two bodies of the palatinal split screw, which are variable in distance. These arms are referred to as retaining arms. By enlarging the spacing between the two bodies of the palatinal split screw, pressure is exerted upon the oppositely arranged molars, which pressure is transmitted by them to the upper jaw. Once the pressure is sufficiently high, the palatine suture will break open. The necessary pressure is achieved by causing a spindle to act on the two bodies of the palatinal split screw. In the case of the known palatinal split screw, the spindle is a double spindle which comprises an actuating element and, extending from the latter, two threaded elements with opposite thread directions, which engage internal threads provided in the bodies. By rotating the spindle, the two bodies are adjusted by an amount which is determined by the pitch of the spindle.

Even small parts fitted in a person's mouth are found extremely troublesome. In order to ensure that a palatinal split screw will be found disturbing to the least possible degree when speaking or eating, one tries to arrange the screw below the palatine suture as close as possible to the palate of the upper jaw. The known palatinal split screw therefore has a design where the upper surfaces of its distance-variable bodies are arched in a direction transverse to the extension of the spindle. It is the intention of that design to allow the upper surface of the palatinal split screw to be arranged closer to the upper jaw with its arched shape, viewed from the rear to the front.

In the case of the known palatinal split screw the retention arms are fixed on the lower surfaces of the bodies by welding, i.e. on that side of the bodies that faces the tongue. The retention arms extend away from the lower surfaces of the bodies and, in the installed position of the palatinal split screw in a person's mouth, to the molars on which they are to be anchored. In the installed position, the spindle of the palatinal split screw extends transversely to the palatine suture in the patient's upper jaw, normally at a right angle or at an approximately right angle relative to the palatine suture. This is an absolute precondition if the palatine suture is to be opened by means of the expansion screw.

Palatinal split screws of the described species are available in trade with bent-off retention arms that must be adapted by the treating orthodontist to the installation conditions prevailing in the patient's mouth. However, in spite of the bent-off retention arms that allow the known palatinal split screw to be arranged near the patient's palate, the known palatinal split screw is still felt disturbing by the patient. On the other hand, the known palatinal split screw cannot be arranged in the patient's mouth in a position high enough so as to contact the patient's palate because the latter is arched not only in a direction from the front to the rear but also in transverse direction. If mounted in such a position, the—mostly indented—ends of the guide pins and the sharp-edged spindle would then press against the sensitive palatine membrane which could lead to pain, pressure sores and also to irritation or inflammation.

U.S. Pat. No. 6,109,916 A likewise discloses an expansion screw having the features described in the preamble of claim 1. But the expansion screw known from U.S. Pat. No. 6 109 916 A is intended for a different installed position in which the spindle of the expansion screw extends in parallel to the palatine suture. Accordingly, instead of serving to open the palatine suture that expansion screw has a “distalising” function which means that it is intended to widen the distance between one or more molars and the front teeth. The expansion screw known from U.S. Pat. No. 6,109,916 A likewise has the retention arms mounted on its bodies below the planes defined by the two guide pins on both sides of the spindle, and this leads to disadvantages similar to those of the known palatinal split screw, though less serious than in the case of the latter, because the expansion screw will be less disturbing when installed in parallel to the palatine suture, as compared with an expansion screw installed crosswise to the palatine suture.

Now, it is the obiect of the present invention to indicate a way of improving the wearing comfort of an expansion screw, especially a palatinal split screw.

This object is achieved by an expansion screw having the features defined in claim 1. Advantageous further developments of the invention are the subject-matter of the sub-claims.

The invention provides essential advantages:

When an expansion screw according to the invention is installed in a person's mouth in the intended position, the first plane extends at a level lower than the second plane. This means that in the installed position of the expansion screw the straight-line guide means occupy a position lower than the first legs of the angled or bent-off retention arms mounted on the bodies of the expansion screw. When an expansion screw of that kind is installed high enough to contact the palate of the upper jaw, then such contact is made by the angled or bent-off retention arms, maybe even by the upper surface of the two bodies of the expansion screw, in any case, however, not by the straight-line guide means or by the lower spindle, and accordingly the sharp-edged end of the spindle cannot exert pressure on the sensitive palatine membrane.

The retention arms, which are bent-off in downward direction, can get into contact with the palatine membrane of the upper jaw at most by their first legs, for example at the point where they are bent off in downward direction. Given the fact that the legs are to lead to the molars, the angle at which they are angled or bent off generally is an obtuse angle, and in addition the latter preferably is bent, or rounded on its outside, at a radius which excludes any irritation of the palatine membrane when the retention arms get into contact with the palate.

Given the fact that the spindle and the straight-line guide means can no longer come into contact with the palatine membrane, an expansion screw according to the invention can be moved closer to the palate of the upper jaw than the known expansion screws, and may preferably be brought into direct contact with the palate.

The spindle and the straight-line guide means being positioned below the first legs of the retention arms, they are closer to the plane in which the force exerted by the expansion screw is transferred to the teeth, especially the molars. Any tilting moments that may occur on the two variable-distance bodies of the expansion screw are thereby reduced.

The straight-line guide means preferably consist of two guide pins on which the spindle may be arranged. However, they may as well consist of the spindle as such and another guide pin fitted in matching bores in the two bodies of the palatinal split screw.

Prior-art retention arms have a circular cross-section. This is preferred according to the present invention as well. The retention arms then present no sharp edges, that might irritate the palatine membrane, but rather a smooth rounded contour.

To guide the two variable-distance bodies of the expansion screw along a straight line and to prevent the two bodies from turning one relative to the other, it is sufficient if the two bodies are connected one with the other not only by the spindle but also by a guide pin arranged in parallel to the spindle and fitted in bores in the two bodies that match the guide pins and that are aligned one with the other. It then is the spindle and a guide pin extending in parallel to it whose longitudinal axes defined the “first plane”. The force produced by the spindle is then transferred to the two variable-distance bodies asymmetrically.

Symmetrical transfer of the force is obtained when two guide pins are provided that extend in parallel one to the other and to the spindle and that are arranged symmetrically to the spindle and fitted in bores in the two bodies, which are aligned in pairs. In that case, it is the longitudinal axes of the two guide pins that define the “first plane”. Preferably, the spindle is arranged in this case between the two guide pins in order to obtain a compact structure of the expansion screw.

For reasons of symmetry and of compactness of the structure it is further preferred if the first plane and the second plane extend in parallel one relative to the other.

As in the prior art, the retention arms may be bent off at some distance from the variable-distance bodies. Preferably, they are bent off directly at the two bodies. This permits the expansion screw, especially if designed as palatinal split screw, to be arranged in an especially high position near the palate of the upper jaw. In the case of a prior-art palatinal split screw, such a further development of the invention would not have produced that advantage because in that case it is the spindle and the straight-line guide means that limit the degree to which the palatinal split screw can be approached to the palate of the upper jaw.

As in the case of the prior art, the expansion screw according to the invention conveniently comprises four retention arms, i.e. two retention arms on each body.

The retention arms can be mounted so that their first legs extend in parallel to the guide axes of the straight-line guide means. In that case, the conditions for each retention arm are preferably such that a third plane, defined by the longitudinal axis of its first leg and the longitudinal axis of the neighbouring guide pin, intersects the first plane at an angle of 40° to 50°, especially at an angle of 45°. This is a favourable compromise between compact structure of the expansion screw and the possibility to have the bent-off legs of the retention arms extend obliquely in downward direction, past the guide pins.

However, the retention arms need not necessarily extend in parallel to the guide axes of the straight-line guide means; instead they may also extend crosswise, especially at a right angle to them. This then makes it possible to combine two retention arms each to one unit by giving them a common first leg mounted on one of the two variable-distance bodies. Each of the two variable-distance bodies then carries such a unit consisting of two retention arms with a common centre portion that forms the first leg of each of the two retention arms.

Regardless of whether the first legs of the retention arm extend in parallel or crosswise to the guide axes of the straight-line guide means, they may in any case have their respective first leg welded to the outer surface of the respective body of the expansion screw. When the first legs extend in parallel to the guide axes, then the bodies of the expansion screw are, preferably, provided with mounting bores that extend in parallel to the spindle and to the guide pins and that receive the first leg of the respective retention arm. This then allows a compact structure and a favourable contour for the upper surface of the expansion screw facing the palatine membrane. The first legs of the retention arms must in this case be fixed in the mounting bores of the two bodies so that they are no longer permitted to move in such bores. This might be achieved by bonding or pressing; preferably, however, they are so fixed by welding. If the first legs of the retention arms extend crosswise to the guide axes, then they are preferably arranged in grooves provided in the one or the other body of the expansion screw and extending transversely to the guide axes, and are fixed therein by welding. This is favourable in terms of production, simplifies exact alignment of the retention arms and leads to a compact structure of the expansion screw.

The spindle might comprise an actuating element seated on one of the two bodies, and only one threaded element extending from the actuating element and engaging in a threaded bore of the other body. A symmetric design of the expansion screw is, however, preferred with a spindle comprising an actuating element arranged between the two bodies and, extending therefrom, two threaded elements with opposite thread directions that engage in threaded bores provided in the two bodies.

The invention is particularly well suited for palatinal split screws where it can be realised with particular advantage because the installation of a palatinal split screw is felt by the patient especially disturbing in view of the natural contour of the palate of his upper jaw. The invention is, however, also useful in expansion screws intended to be installed on the upper jaw in lengthwise direction.

Expansion screws are offered in trade with pre-bent retention arms. According to the different installed positions, depending on whether the screws are to be used as palatinal split screw or as expansion screw for distalising purposes, the man of the art distinguishes between different forms of pre-bent retention arms that are characteristic of the envisaged installed position.

Several exemplary embodiments of the invention are illustrated in the drawings. Identical parts, or parts corresponding one to the other, are indicated in the different examples by the same reference numerals. In the drawings:

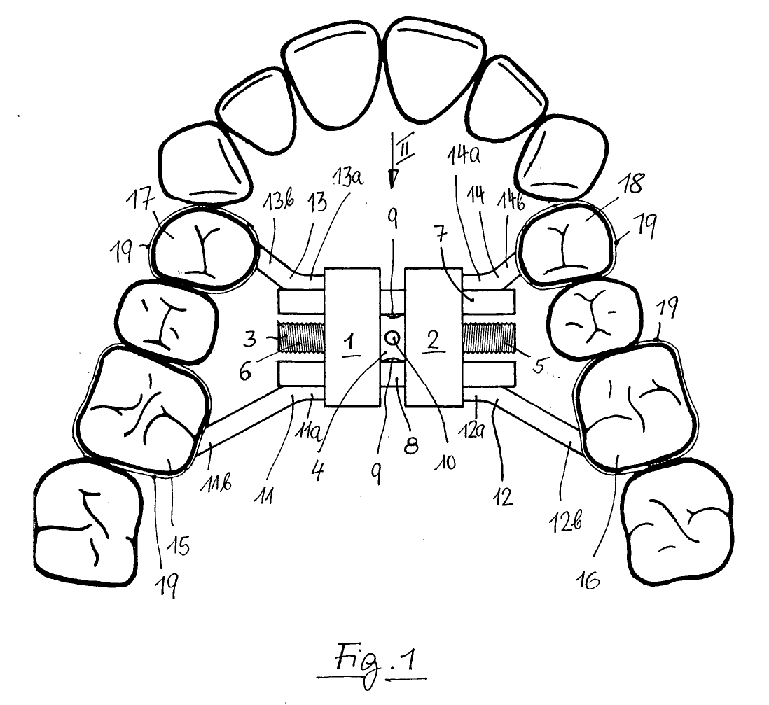

FIG. 1 shows a view, from the bottom to the top, of a first embodiment of a palatinal split screw mounted on an upper jaw in a patient's mouth;

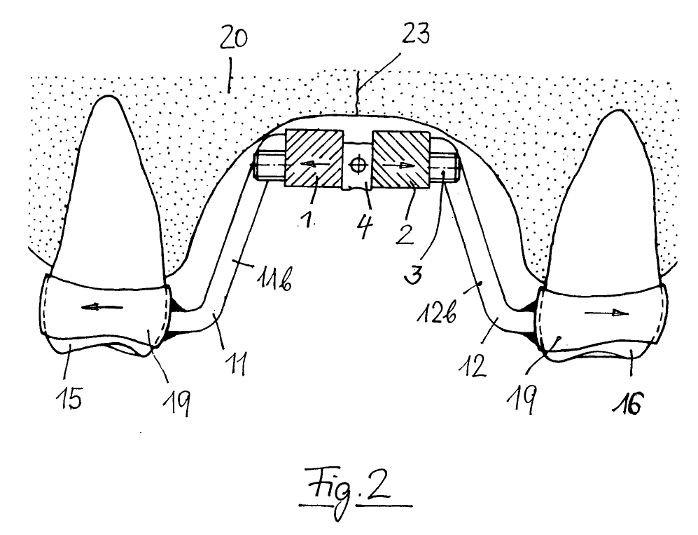

FIG. 2 shows a view of the screw according to FIG. 1, in the direction indicated by arrow II, with the two bodies of the palatinal split screw arranged at the closest possible distance one from the other;

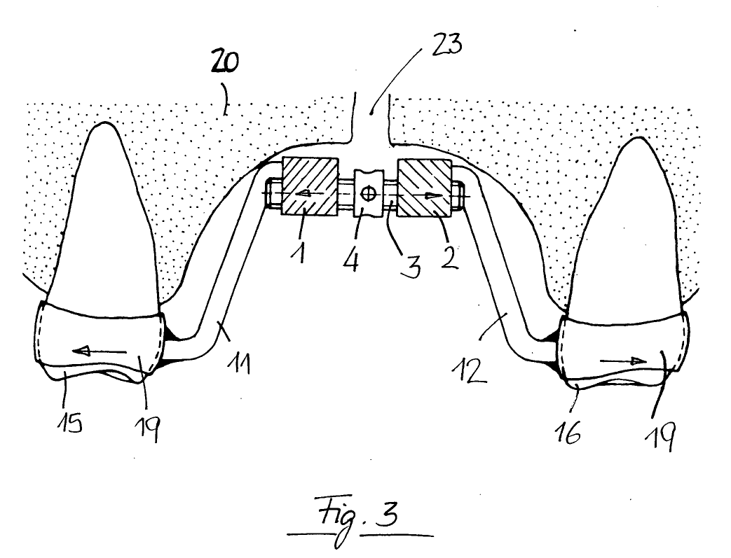

FIG. 3 shows a view of the palatinal split screw similar to FIG. 2, after the distance of its two bodies has been increased;

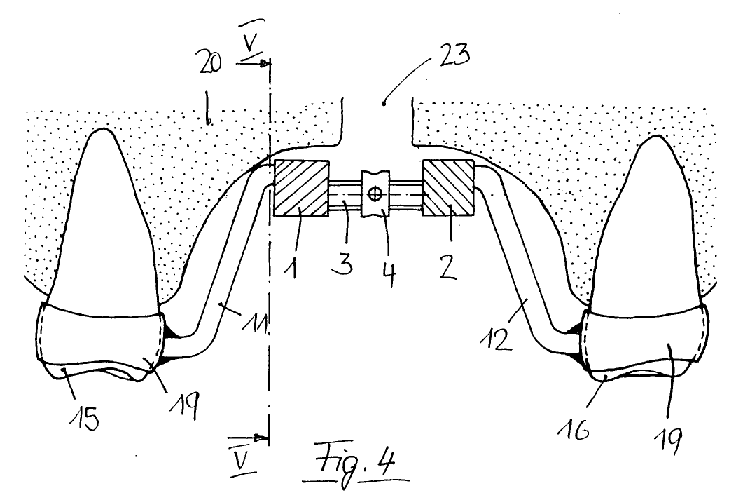

FIG. 4 shows a view of the palatinal split screw similar to FIG. 2, at the greatest possible distance between its two bodies;

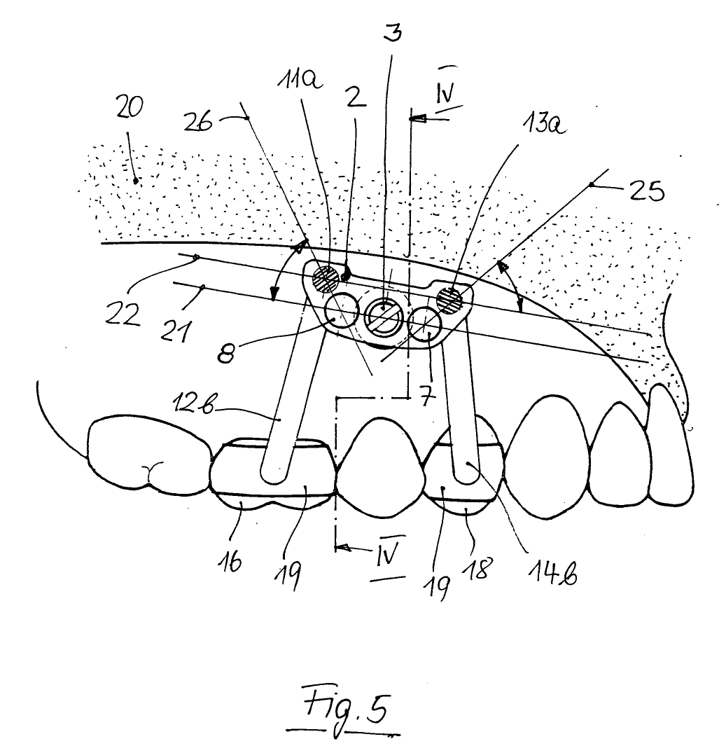

FIG. 5 shows a vertical section along line V-V in FIG. 4;

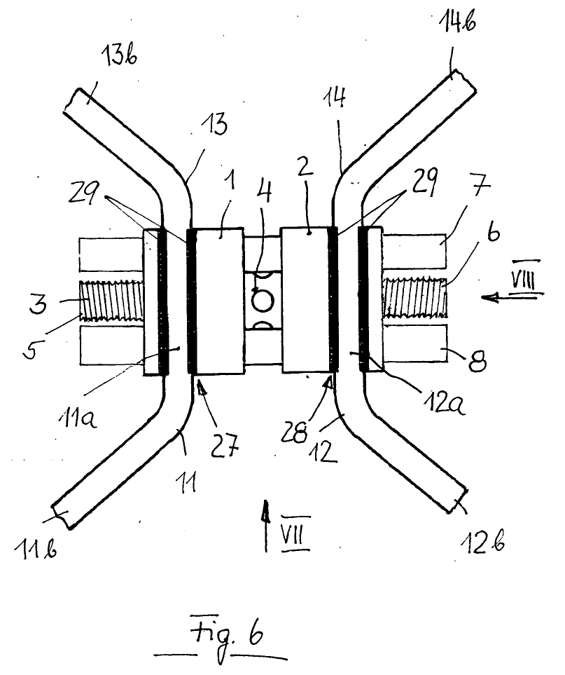

FIG. 6 shows a top view of a second example of a palatinal split screw;

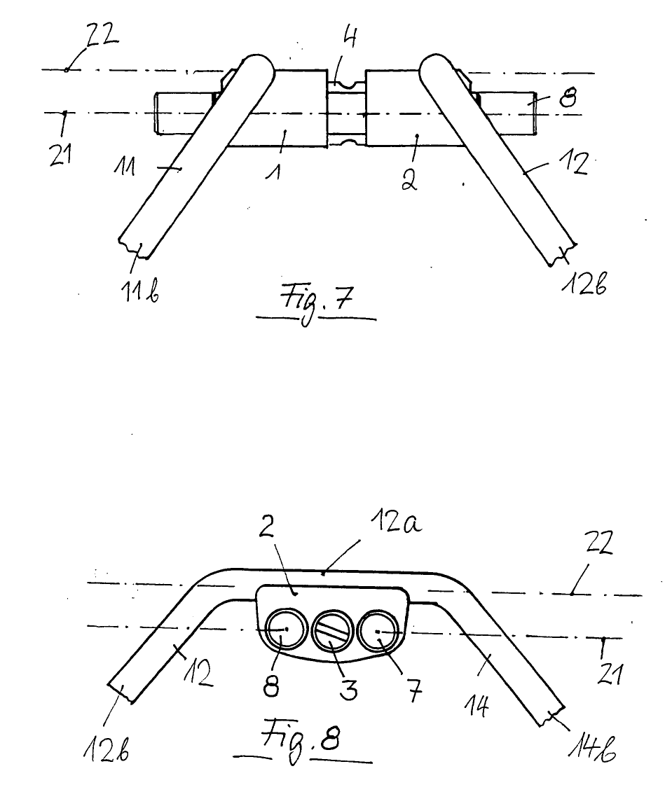

FIG. 7 shows a side view according to FIG. 6, viewed along line VII;

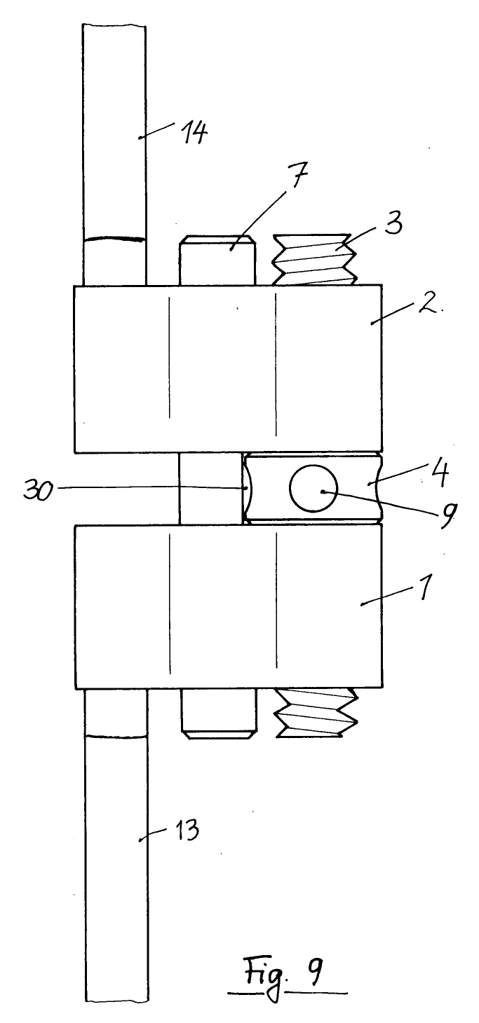

FIG. 8 shows a side view according to FIG. 6, viewed along line VIII;

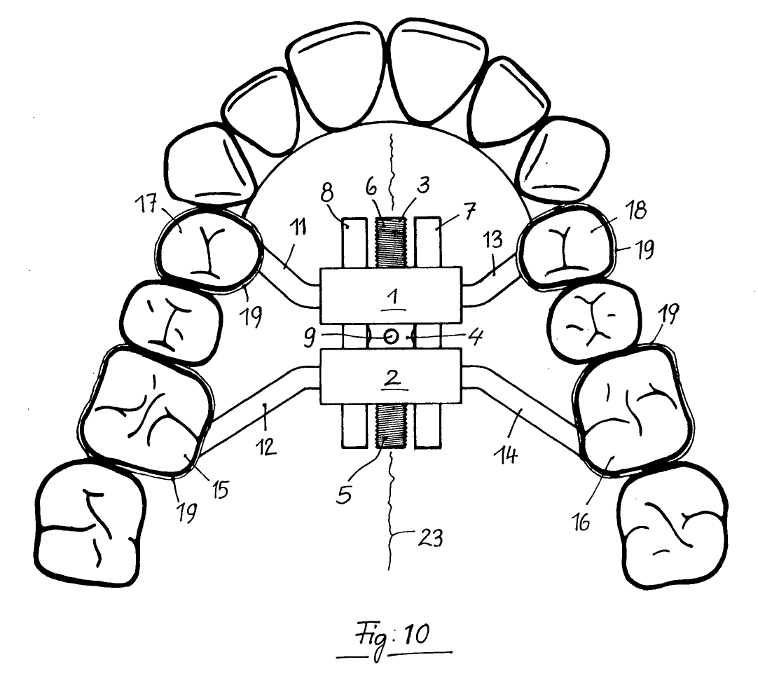

FIG. 9 shows a modified expansion screw with a single guide pin in a representation similar to that of FIG. 1, however, not mounted; and

FIG. 10 shows an expansion screw installed on the upper jaw in lengthwise direction, in a representation corresponding to FIG. 1.

FIG. 1 shows a palatinal split screw of symmetrical structure with two bodies 1 and 2 whose mutual distance can be varied by means of a spindle 3 which latter comprises a central actuating element 4 and, extending from the latter in opposite direction, two threaded elements 5 and 6 with opposite thread directions mounted in threaded bores passing centrally through the bodies 1 and 2. Provided on both sides of the spindle 3 are two cylindrical guide pins 7 and 8 fitted in matching through-bores in the two bodies 1 and 2, which bores are aligned in pairs. The actuating element 4 comprises two transverse bores 9 and 10 that intersect each other at a right angle and that can be engaged by a pin if one intends to turn the actuating element 4. By doing so, one varies the distance between the two bodies 1 and 2, which slide on the guide pins 7 and 8 during that action, so that the two bodies 1 and 2 are guided along a straight line and any relative rotation of the two bodies 1 and 2 is prevented.

The palatinal split screw comprises four retention arms 11, 12, 13 and 14, which are mounted in pairs on the bodies 1 and 2, respectively. As illustrated in FIG. 5, the bodies 1 and 2 are each provided for this purpose with two further bores, which may be through-bores or blind bores and which extend in parallel to the guide pins 7 and 8 and also in parallel to the spindle 3 and accommodate a first leg 11a, 12a, 13a and 14a, respectively, of the respective retention arm, which latter is fixed therein stationarily, especially by welding. The retention arms, which are circular in cross-section, are bent off at an obtuse angle near the body 1 and 2, respectively. Their second, bent-off legs 11b, 12b, 13b and 14b lead to molars 15, 16, 17 and 18 of the upper jaw that are surrounded by stainless-steel straps 19 on which the ends of the retention arms 11 to 14 can be anchored. The straps 19 are not part of the palatinal split screw.

When the distance between the two bodies 1 and 2 is increased by rotation of the spindle 3, an outwardly directed force is exerted upon the molars 15 to 18 and transferred from the latter to the upper jaw 20 where a central palatine suture 23 is still closed initially (see FIG. 2). The outwardly directed pressure on the bodies 1 and 2 eventually has the effect to break open the palatine suture 23; see FIGS. 3 and 4.

As can be seen best in FIG. 5, the longitudinal axes of the two guide pins 7 and 8 and of the spindle 3 define a first plane 21. The longitudinal axes of the first legs 11a to 14a of the retention arms define a second plane 22, which extends in parallel to the first plane 21. In the installed position, the second plane 22 lies above the first plane 21. This means that the retention arms 11 to 14, all of which extend on one side of the second plane 22, namely in downward direction, intersect the first plane 21. As can be seen best in FIGS. 2 to 4, this provides the advantage that the retention arms 11 to 14 are the only elements that can contact the palatine membrane 24 when the palatinal split screw is arranged as close a possible to the palate of the upper jaw 20. Neither the guide pins 7 and 8, nor the spindle 3 have a chance to reach the sensitive palatine membrane 24 by their sharp-edged ends, whether the bodies 1 and 2 are located at their smallest distance (FIG. 2), at their greatest distance (FIG. 4) or in any intermediate position (FIG. 3). In any case, it is the retention arms 11 to 14, with their rounded cross-section, that get the closest to the palatine membrane 24 by their rounded, obtuse-angle transition between their first legs 11a to 14a and their second leg 11b to 14b.

As can be seen in FIG. 5, the retention arms 11 to 14 can be guided past the ends of the guide pins 7 and 8 in spite of the compact design of the palatinal split screw and its bodies 1 and 2, if the first legs 11a to 14a are arranged very close to the guide pins 7 and 8, though at a somewhat greater distance from the spindle 3, so that the longitudinal axes of the guide pin 7 and the first legs 13a and 14a on the one side, and the longitudinal axes of the second guide pin 8 and the first legs 11a and 12a on the other side define a third plane 25 and 26, respectively, which includes an angle of approximately 45° with the first plane 21 and the second plane 22, respectively.

It should be noted that FIG. 5 shows a line IV-IV along which the section of FIG. 4 has been taken through the upper jaw. In addition, it should be noted that FIG. 4 differs from FIG. 1 in that the points where the retention arms 11 to 14 are bent off are located directly at the bodies 1 and 2 whereas in the representation of FIG. 1 they are provided at a somewhat greater distance from the bodies 1 and 2. The variant according to FIG. 4 is especially preferred.

The second embodiment illustrated in FIGS. 6 to 8 differs from the first embodiment illustrated in FIGS. 1 to 5 insofar as the four retention arms 11 to 14 are combined to two units so that the unit comprising the retention arms 11 to 13 has a common central portion forming for the two retention arms 11 and 13 a first leg 11a that extends at a right angle to the guide pins 7 and 8. Correspondingly, the two other retention arms 12 and 14 form a single unit with a common central portion forming for the two retention arms 12 and 14 a common first leg 12a which likewise extends in parallel to the guide pins 7 and 8. The two first legs 11a and 12a are arranged in a groove 27 in the body 1, or in a groove 28 in the body 2, respectively, and are connected with the two bodies 1 and 2 by welding. The weld beads 29 are visible in FIG. 6. As can be seen best in FIG. 8, the longitudinal axes of the guide pins 7 and 8 and of the spindle 13 extend in a first plane 21. The longitudinal axes of the first legs 11a and 12a extend in a second plane 22, which latter extends in parallel to the first plane 21. The second legs 11b, 12b, 13b and 14b of the retention arms are bent off so that they intersect the first plane 21.

The embodiment illustrated in FIG. 9 differs from the embodiment illustrated in FIG. 1 insofar as the expansion screw has only a single guide pin 7 extending in parallel to its spindle 3, which pin, in combination with the spindle 3, provides a straight-line guide for the bodies 1 and 2 and prevents any relative rotation of the bodies during adjustment of the spindle 3. Further, from the bodies 1 and 2 projects a single retention arm 13 or 14, resp., which in the selected view of FIG. 9 is bent off in such a direction that it projects out of the drawing plane. The guide pin 7 is in its centre provided with a recess 30 into which extends the actuating element 4 of the spindle 3.

The embodiment illustrated in FIG. 10 distinguishes itself from the embodiment illustrated in FIG. 1 by a different installed position where the spindle 3 extends in parallel to the palatine suture 23, and by a different form of the curved retention arms. FIG. 10 therefore does not show a palatinal split screw, but rather an expansion screw intended to distalise molars relative to the front teeth.

List of reference numerals:

1. Body

2. Body

3. Spindle

4. Actuating element

5. Threaded element

6. Threaded element

7. Guide pin

8. Guide pin

9. Transverse bore

10. Transverse bore

11. Retention arm

11a. First leg

11b. Bent-off second leg

12. Retention arm

12a. First leg

12b. Bent-off second leg

13. Retention arm

13a. First leg

13b. Bent-off second leg

14. Retention arm

14a. First leg

14b. Bent-off second leg

15. Molar

16. Molar

17. Molar

18. Molar

19. Straps

20. Upper jaw

21. First plane

22. Second plane

23. Palatine suture

24. Palatine membrane

25. Third plane

26. Third plane

27. Groove

28. Groove

29. Weld bead

30. Recess

1. Orthodontic expansion screw having two bodies whose mutual spacing can be varied by means of a spindle acting upon the two bodies, comprising:
a straight-line guide means in engagement with the two bodies and which guide the two bodies along two mutually parallel guide axes defining a first plane, while preventing any relative rotation of the bodies during adjustment of their spacing,
angled or bent-off retention arms mounted on the bodies, said retention arms each comprising a first leg mounted on one of the bodies, the longitudinal axis of the first legs defining together a second plane,
and a second leg angled or bent off relative to the first leg,
there being provided for the expansion screw, an installed position in which all second legs extend on the same side of the second plane, and the angled and/or bent-off second legs of the retention arms intersect the first plane in the intended installed position.

2. The orthodontic expansion screw defined in claim 1, wherein the straight-line guide means comprises the spindle and a guide pin, extending parallel to the spindle and fitted in matching, mutually aligned bores in the two bodies.

3. The orthodontic expansion screw defined in claim 1, wherein the straight-line guide means comprises guide pins which extend parallel to the spindle said guide pins are fitted in bores in the two bodies aligned in pairs, and whose longitudinal axes define the first plane.

4. The orthodontic expansion screw defined in claim 1 wherein the first plane and the second plane extend in parallel one another.

5. The orthodontic expansion screw defined in claim 1 wherein the retention arms are bent off directly at the bodies.

6. The orthodontic expansion screw defined in claim 1, comprising four retention arms arranged with two retention arms on each body.

7. The orthodontic expansion screw defined in claim 1, wherein the first legs of the retention arms extend parallel to the guide axes of the straight-line guide means.

8. The orthodontic expansion screw defined in claim 3 further comprising, a third plane is defined by the longitudinal axis of a first leg of a retention arm and the longitudinal axis of its neighboring guide pin said third plane intersects the first plane at an angle of 40° to 50°.

9. The orthodontic expansion screw defined in claim 1, wherein the first legs extend transversely, relative to the guide axes of the straight-line guide means.

10. The orthodontic expansion screw defined in claim 9, wherein each pair of retention arms mounted on one of the bodies form one unit and have a common first leg.

11. The orthodontic expansion screw defined in claim 1, wherein the retention arms are welded to the outside of the respective body by their first leg.

12. The orthodontic expansion screw defined in claim 1, wherein the respective first legs of the retention arms are each fitted stationarily in a matching retaining bore in the respective body.

13. The orthodontic expansion screw defined in claim 12, wherein the retention arms are welded into the retaining bores.

14. The orthodontic expansion screw defined in claim 9, wherein the retention arms have their first leg welded into a groove provided in one of the bodies.

15. The orthodontic expansion screw defined in claim 1, wherein the spindle comprises an actuating element arranged between the bodies and, two threaded elements extend from the actuating bodies, said threaded elements having opposite thread directions, which engage internal threads provided in the bodies.

16. The orthodontic expansion screw defined in claim 4, wherein the spindle is arranged between the straight-line guide means and said straight line guide means comprise guide pins which extend parallel to the spindle and said guide pins are fitted in the two bodies, aligned in pairs and whose longitudinal axis define the first plane.

17. The orthodontic expansion screw defined in claim 1 wherein the retention arms are bent off at an obtuse angle.

18. The orthodontic expansion screw defined in claim 1, wherein the retention arms have a circular cross-section.

19. The orthodontic expansion screw defined in claim 1, wherein at least the outside of the angle between the two legs of the retention arms is rounded.

20. The orthodontic expansion screw defined in claim 1, wherein the spindle in the installed position, extends transversely to a palatine suture in a patient's upper jaw.

21. The orthodontic expansion screw defined in claim 1, wherein the spindle in the installed position, extends in parallel to a palatine suture in a patient's upper jaw.
